(19) United States
(12) Patent Application Publication
(10) Pub. No.: US 2016/0301581 A1
(43) Pub. Date: Oct. 13, 2016

(54) DYNAMIC ADJUSTMENT OF SAMPLING RATE BASED ON A STATE OF THE USER

(71) Applicant: Amiigo, Inc., Mountain View, CA (US)

(72) Inventors: Abraham Luke Carter, Palo Alto, CA (US); David Jennings Scott, Palo Alto, CA (US)

(21) Appl. No.: 15/092,474

(22) Filed: Apr. 6, 2016

Related U.S. Application Data
(60) Provisional application No. 62/144,412, filed on Apr. 8, 2015.

(51) Int. Cl. H04L 12/26; H04W 4/00; H04B 1/3827; H04L 29/08; H04W 4/02

(52) U.S. Cl. CPC H04L 43/024; H04L 43/04; H04L 67/306; H04W 4/021; H04L 43/106; H04B 1/385; H04W 4/005

(57) ABSTRACT

An activity classification server receives raw data from one or more activity-tracking devices worn by a user and processes the raw data to classify the user's activities into one or more identifiable states. The activity-tracking devices operate at a given sampling rate to collect the raw data. To optimize power usage, among other things, the activity classification server adjusts the sampling rate of the activity-tracking devices based on the state of the user at any given time. Therefore, the activity-tracking devices collect raw data at different sampling rates depending on the type of activity in which the user wearing those devices is engaged.

### CROSS-REFERENCE TO RELATED APPLICATIONS

This application claims the benefit of U.S. Provisional Application No. 62/144,412, filed on Apr. 8, 2015, which is hereby incorporated by reference in its entirety.

### BACKGROUND

This invention relates generally to wearable devices and more specifically to dynamic adjustment of sampling rates of sensors in the wearable devices while using one or more wearable devices.

Many devices have been developed for tracking various physiological parameters and activity information during a user's workout or other user activities. For example, heart rate monitors can detect a user's heart rate, pulse oximeters can detect the oxygen saturation of a user's hemoglobin, blood glucose monitors can detect the glucose level in a user's blood, etc., and the various physiological and activity information can be used to classify an activity performed by the user.

To track these various parameters, the user is required to wear or carry a specialized device with a potentially uncomfortable or inconvenient form factor that can both receive raw data from the sensors and process the raw data to generate useful information displayable to the user. However, there is a limited amount of information that can be collected by such a specialized device worn by the user since various activities can be performed by the user while using the specialized device and those various activities are unknown. The user can tell the device what activity is being performed and when to start or stop tracking, but this is not convenient for the user.

### SUMMARY

An activity classification server receives raw data from one or more activity-tracking devices worn by a user and processes the raw data to classify the user's activities into one or more identifiable states. A user's state describes one or more physical conditions of the user while using the activity-tracking devices. The state of the user can be determined based on temporal information, geographical information, motion information of the user, and any other suitable information describing the user. The activity-tracking devices operate at a given sampling rate to collect the raw data. To optimize power usage, among other things, the activity classification server adjusts the sampling rate of the activity-tracking devices based on the state of the user at any given time. Therefore, the activity-tracking devices collect raw data at different sampling rates depending on the type of activity in which the user wearing those devices is engaged.

### BRIEF DESCRIPTION OF THE DRAWINGS

FIG. 1 is a block diagram of a system environment in which one or more devices used for activity-tracking and an activity classification server operate, in accordance with an embodiment.

FIG. 2 is a block diagram of an architecture of the activity classification server, in accordance with an embodiment.

FIG. 3 is a block diagram of the plurality of activity-tracking devices illustrated in FIG. 1, in accordance with an embodiment.

FIG. 4 is a method of synchronizing a plurality of activity-tracking devices for use by a user, in accordance with an embodiment.

FIG. 5 is a method of a system providing instructions for dynamically adjusting sampling rates of one or more activity-tracking devices, in accordance with an embodiment.

FIG. 6 is a method of an activity-tracking device dynamically adjusting its sampling rate, in accordance with an embodiment.

FIG. 7 is a block diagram illustrating components of an example machine able to read instructions (e.g., software or program code) from a machine-readable medium and execute them in a processor (or controller), in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

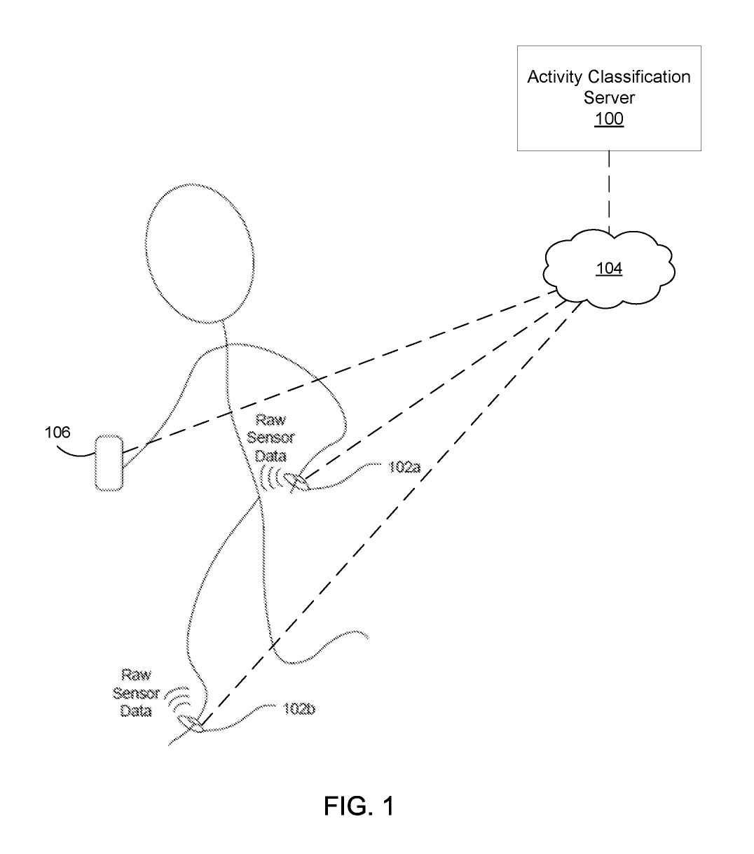

FIG. 1 is an example block diagram of a system environment in which one or more devices used for activity-tracking (“activity-tracking devices”) and an activity classification server 100 operate. The system environment shown by FIG. 1 includes an activity classification server 100, a plurality of wearable or activity-tracking devices 102A and 102B, also individually referred to as “activity-tracking device 102,” and a network 104. In alternative configurations, different and/or additional components may be included in the system environment. For example, there may only be a single wearable or activity-tracking device or more than two, and there may also be a portable computing device 106.

The activity classification server 100 receives data from one or more activity-tracking devices 102 and classifies activities and repetitions in activities using the data. In one embodiment, the data received is raw data that has generally not been adjusted or processed on the devices 102 before sending the data to the server 100. In other words, this data can include readings from an accelerometer and/or other sensors in the activity-tracking devices 102 that occur while the movement is happening without analysis of that data.

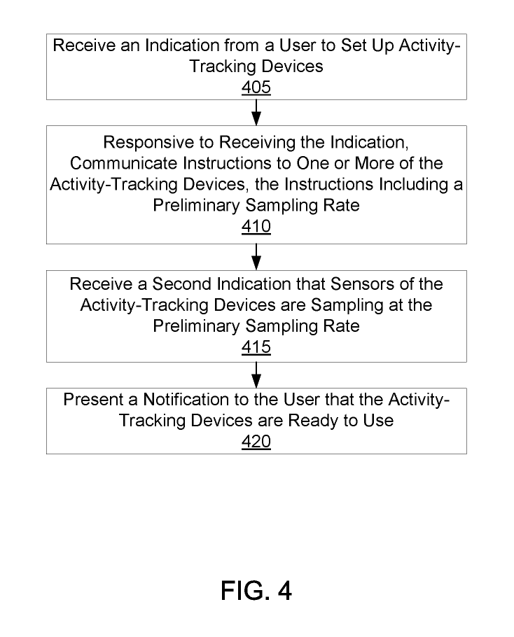

The classification by the activity classification server 100 of the activities and repetitions in the activities, and other suitable information based on the classification, can be presented to users of the activity classification server 100 via one or more portable computing devices 106. As further described below in conjunction with FIG. 4, the activity classification server 100 receives raw data, identifies activity regions in the raw data, identifies repetition regions in the activity regions, and classifies the activity regions, repetition regions, or both. In one embodiment, the activity classification server 100 is a cloud-based computing system with one or more servers that performs most or all of the data processing and analysis of raw data collected by the activity-tracking devices 102. This provides a benefit in that the devices 102 can collect much more data than they might otherwise be able to if much or most of the processing were performed on those devices 102 themselves. For example, it is possible to collect resting heart rate data as opposed to collecting only heart rate data during a particular activity of interest because the devices 102 do not need to store or perform the analysis on this data, and this data is instead sent to the server 100 for storage/analysis. This allows for a more accurate picture of a user's activities and allows for tracking of a wider variety of activity types.

The portable computing device 106 can be a computing device operated by the user (e.g., Smartphone, laptop, tablet, etc.) or an application executed on a client device and capable of transmitting and/or receiving data via the network 104. Thus, the portable computing device 106 is configured to communicate via the network 104. The portable computing device 106 can provide a mobile application via which the user can view and track activities performed and data analysis occurring on those activities. Data can be transferred to/from the device 106 and the activity-tracking devices 102. Data can also be transferred to/from the device 106 and the server 102. The bulk of the analysis of data from the device 102 may be performed on the server 100 and results reported to the device 106 for review and interaction by the user via a user interface or mobile application on the device 106. In some embodiments, a portable computing device 106 is not included as a part of the system environment. The activity-tracking devices 102A and 102B each can be worn and used by a user during a workout or an activity, and each can include a housing and one or more sensors attached to the housing.

As shown in FIG. 1, activity-tracking device 102A is worn by a user on the user's wrist (e.g., as a bracelet) and wearable device 102B is worn by the user on the user's shoe (e.g., as a shoe clip). Thus, activity-tracking device 102A captures activity information, physiological information, or both activity and physiological information of the user's arm and activity-tracking device 102B captures activity information, physiological information, or both activity and physiological information of the user's leg. Having an activity-tracking device on the upper half or portion of the user's body and on the lower half of the user's body allows for more accurate classification of activity data and classification of more complex activities as it is difficult to determine what activity a user is performing based just on a user's arm or leg movements alone. In alternative embodiments, activity-tracking device 102A is worn by a user somewhere on the user's upper half of the body and activity-tracking device 102B is worn by the user somewhere on the user's lower half of the body. Although FIG. 1 illustrates two activity-tracking devices 102A and 102B, alternative embodiments include one wearable device or three or more wearable devices that can be worn by a user on the user's elbow, hip, knee, head, or any other portion of the user's body. Activity-tracking devices can also be placed on tools or sporting equipment used by a user during an activity (e.g., on a weight stack in a gym, on a golf club or tennis racquet, on a gardening tool, etc.).

The devices 102 can sample data about an activity being performed by the user wearing the devices or using the devices at various different rates, including increased rates of sampling for more complicated or high action activities (e.g., dance movements) and decreased rates of sampling for less complicated or lower action activities (e.g., resting, repetitive movements like jogging for a long period of time). The sampling rate includes when and how often data is sent from the devices 102 to the server 100 or portable device 106 as a sample on which analysis can be performed.

The use of and interaction between two or more wearable devices for activity tracking is described in more detail in U.S. patent application Ser. No. 13/846,662 filed on Mar. 18, 2013 (describing, for example, correlating accelerometer data to known movements), U.S. patent application Ser. No. 14/172,726 filed on Feb. 4, 2014 (describing, for example, identifying physiological parameters from raw data received wirelessly from a sensor), U.S. patent application Ser. No. 14/184,597 filed on Feb. 19, 2014 (describing, for example, synchronizing accelerometer data received from multiple accelerometers and dynamically compensating for accelerometer orientation), U.S. patent application Ser. No. 13/891,699 filed on May 10, 2013 (describing, for example, updating firmware to customize the performance of a wearable sensor device for a particular use), U.S. patent application Ser. No. 14/275,493 filed on May 12, 2014 (describing, for example, a platform for generating sensor data), and U.S. patent application Ser. No. 14/279,140 filed on May 5, 2014 (describing, for example, correlating sensor data obtained from a wearable sensor device with data obtained from a smart phone), each of which is incorporated by reference herein in its entirety.

The activity classification server 100 and activity-tracking devices 102A and 102B are configured to communicate via the network 104, which may comprise any combination of local area and/or wide area networks, using both wired and/or wireless communication systems. In one embodiment, the network 104 uses standard communications technologies and/or protocols. For example, the network 104 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 104 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 104 may be represented using any suitable format, such as hypertext markup language (HTML) or extensible markup language (XML). In some embodiments, all or some of the communication links of the network 104 may be encrypted using any suitable technique or techniques. In some embodiments, one or more of the devices 102A and 102B are configured to communicate directly with each other or directly with the portable computing device 106 via, for example, a BLUETOOTH® connection.

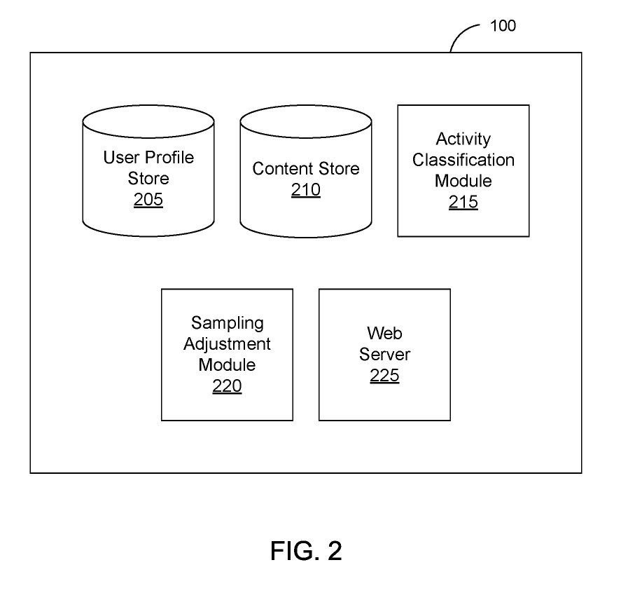

FIG. 2 is a block diagram of an architecture of the activity classification server 100. The activity classification server 100 shown in FIG. 2 includes a user profile store 205, a content store 210, an activity classification module 215, a sampling adjustment module 220, and a web server 225. In other embodiments, the activity classification server 100 may include additional, fewer, or different components for various applications. Conventional components such as network interfaces, security functions, load balancers, failover servers, management and network operations consoles, and the like are not shown so as to not obscure the details of the system architecture.

Each user of the activity classification server 100 is associated with a user profile, which is stored in the user profile store 205. A user profile includes information about the user such as information provided by the user and information inferred by the activity classification server 100. A user profile in the user profile store 205 may also maintain associations with activities performed by the corresponding user while using one or more activity-tracking devices 102.

The content store 210 can store data from one or more activity-tracking devices 102, such as raw data received from one or more activity-tracking devices 102, activity regions identified in raw data received from one or more activity-tracking devices 102, classifications of activity regions (as activity types), repetition regions identified in activity regions, classifications of repetition regions (as repetition types), analysis of raw data, and any combination thereof. The content store 210 can also store associations of any data stored in the content store 210 with a user profile of a user associated with the data. This content associated with a user profile of each user can be used by the server 100 to simplify classification of activities since the content associated with the profile of a user can indicate what types of activities that user normally performs (e.g., plays basketball and swims), providing a starting point for classification of a likely activity that the user is performing.

The content store 210 can also store a reference database of various states of a user and associated threshold sampling rates at which to sample via one or more sensors on the one or more activity-tracking devices 102 for meaningful data. For example, if the state of a user indicates the user is beginning an activity, then the reference database can include one or more threshold sampling rates at which one or more sensors in one or more of the activity-tracking devices 102 attached to the upper body and the lower body should at least exceed. For example, the threshold sampling rate might be 20 Hz for certain activities, or possibly any time an activity begins, or there might be different rates for different activities (e.g., 25 Hz for activities, and 15 Hz for less complicated activities). In another example, if the state of a user indicates the user has just finished exercising, the reference database can include one or more threshold sampling rates at which one or more sensors in the activity-tracking devices 102 should exceed in order to acquire meaningful data regarding post-activity calorie burns. For example, the threshold sampling rate in this case might be 8 Hz. A different sampling rate can be applied when the user is resting or sitting, such as a sampling rate of 4 Hz.

The reference database can also include an association of activities with one or more threshold sampling rates at which to sample one or more sensors on the one or more activity-tracking devices 102 for meaningful data. For example, bicep curls require upper body movement but not so much lower body movement. Thus, the reference database can include a plurality of threshold sampling rates indicating a first sampling rate at which a sensor in an activity-tracking device 102 attached to the upper body should at least exceed and a second sampling rate at which a sensor in an activity-tracking device 102 attached to the lower body does not have to exceed. In another example, squats require upper body movement while the lower body is bearing a load. To acquire the meaningful data describing the lower body bearing the load, the reference database can include a plurality of threshold sampling rates as well indicating a first sampling rate at which a sensor in an activity-tracking device 102 attached to the upper body should exceed and a second higher sampling rate at which a sensor in an activity-tracking device 102 attached to the lower body should exceed.

The content store 210 can also store a sampling feature database including an association between activities with one or more features in a specific pattern in data captured by an activity-tracking device 102. For example, the sampling feature database can associate the activity of “jumping” with a set of at least two features in a specific pattern where the first of the at least two features is a threshold difference in distance along the y-axis from the second of the at least two features, where the first of the at least two features is within a threshold time interval from the second of the at least two features, or any combination thereof.

The activity classification module 215 performs analysis techniques on raw data received from one or more activity-tracking devices 102 and classifies identified activity regions and/or repetition regions in activity regions as activity types and/or repetition regions, respectively. The activity classification module 215 can use various machine learning algorithms, such as any suitable pattern recognition technique including classification algorithms, clustering algorithms, Bayesian networks, Markov random fields, Kalman filters, sequence labeling algorithms, linear discriminate analysis, support vector machines, principal component analysis, wavelet transforms, and any other suitable pattern recognition or classification systems. Thus, the activity classification module 215 identifies characteristics or feature points in the raw data, determines regions (activity and repetition), and classifies those regions, as further described below in conjunction with FIG. 4.

The sampling adjustment module 220 determines a state of a user wearing one or more activity-tracking devices 102 and determines one or more adjusted sampling rates based on the state. The state of the user can indicate conditions associated with the user based on temporal information, geographic information, motion information, or any other suitable information describing conditions of a location when the user was wearing the one or more activity-tracking devices 102. Example states of the user include “located in the mountains,” “eating in a restaurant,” “sleeping,” or “not wearing the device.” The state of the user can also be based on changes in regions including absences of variation. For example, if a user is running at a constant pace for ten minutes, then the region of raw data acquired by the activity-tracking devices 102 including the ten minutes does not present much change and can be associated with an absence of variation in the raw data. If the user abruptly stops and begins walking for five minutes, the region of raw data including the five minutes also does not present much change and is also associated with an absence of variation. However, the change between the two regions of absences of variation can be used to describe the state of the user. Thus, example states of the user can include “beginning an activity,” “ending an activity,” and “performing an activity.”

In one embodiment, the sampling adjustment module 220 determines a state of a user wearing one or more activity-tracking devices 102 based on a comparison of the data captured by the one or more activity-tracking devices 102 with the sampling feature database, as described previously. Therefore, the sampling adjustment module 220 can compare data from an activity-tracking device 102 to various features in specific activity patterns stored in the sampling feature database to determine an associated activity of the data from the activity-tracking device 102. In one embodiment, the sampling adjustment module 220 may identify a plurality of possible activities based on the comparison, score each of the plurality of possible activities on a likelihood of the possible activity representing the data, and select an activity in the plurality of possible activities as the determined state of user. The score can be based on temporal information, geographic information, motion information, or any other suitable information describing conditions of a location when the user was wearing the one or more activity-tracking devices 102, as described previously. Thus, if the plurality of possible activities include swimming and running but the geographic information includes a fitness gym that is not known to have a swimming pool, the score for “running” would be higher than the score for “swimming” and the sampling adjustment module 220 would determine the state of the user to be “running.”

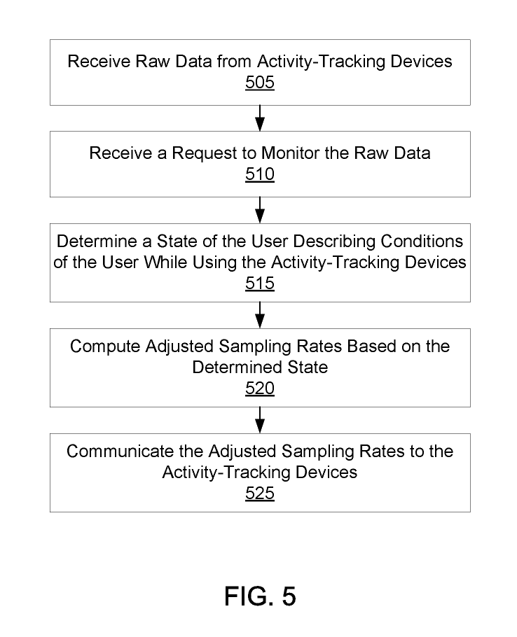

Based on the determined state, the sampling adjustment module 220 determines one or more adjusted sampling rates. In one embodiment, the sampling adjustment module 220 determines the adjusted sampling rates based on the reference database associating states with threshold sampling rates stored in the content store 210. Alternatively, the activity classification module 220 can determine an activity performed by the user based on the determined state of the user and use the reference database associating activities with threshold sampling rates also stored in the content store 210. The functionality of the sampling adjustment module 220 is further described below in conjunction with FIG. 5.

The web server 225 links the activity classification server 100 via the network 104 to a portable computing device 106. The web server 225 serves web pages, as well as other content, such as JAVA®, FLASH®, XML, and so forth. A user may send a request to the web server 225 to access information that is stored in the content store 210. Additionally, the web server 225 may provide application programming interface (API) functionality to send data directly to native portable computing device operating systems, such as IOS®, ANDROID™, WEBOS® or BLACKBERRYOS.

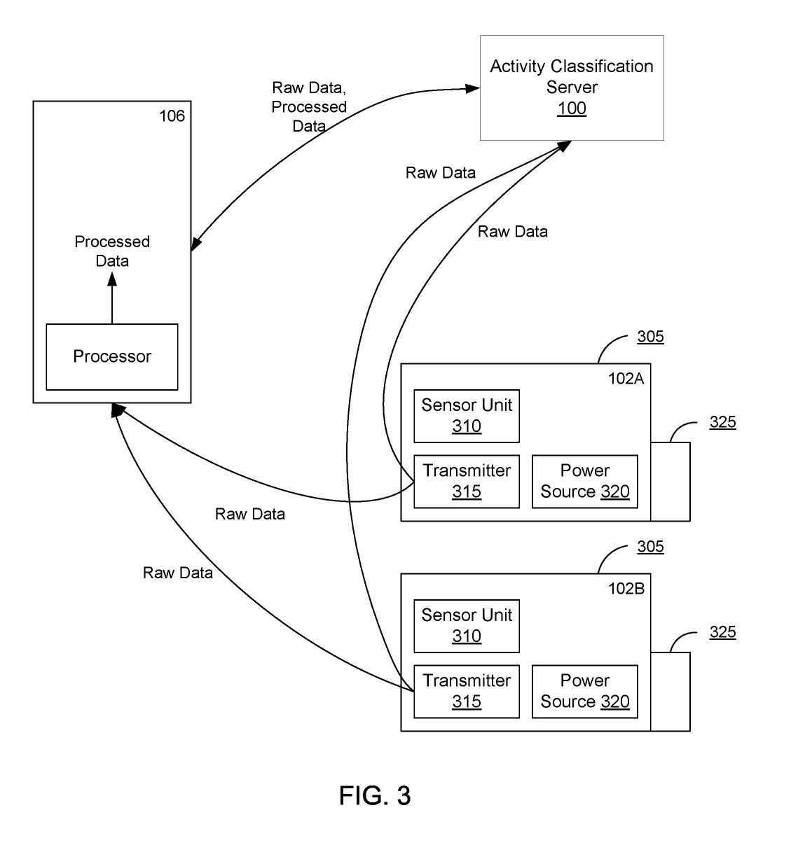

FIG. 3 is a block diagram of the plurality of activity-tracking devices 102 as illustrated in FIG. 1. Raw data captured by the plurality of activity-tracking devices 102A and 102B are wirelessly transmitted via the network 104 to the activity classification server 100, a portable device 106, or any combination thereof. The portable computing device 106 or an application executed on the portable computing device 106 processes the raw data and can present the processed data to a user of the portable computing device 106 via, for example, the application executing on the portable computing device 106.

Each of the devices in the plurality of activity-tracking devices 102A and 102B includes a housing 305 with a sensor unit 310, a transmitter 315, a power source 320, and a coupling mechanism 325. The sensor unit 310, transmitter 315, the power source 320, and coupling mechanism 325 are attached to the housing 305. In alternative embodiments, one or more of the plurality of wearable devices 102A and 102B can also include a display, one or more light-emitting diodes (LEDs), a processor, a memory, or any combination thereof. In other embodiments, each device may include additional, fewer, or different components for various applications. Conventional components such as network interfaces, security functions, and the like are not shown so as to not obscure the details of the devices.

The sensor unit 310 includes a blood glucose sensor, a pulse oximeter, a skin temperature sensor, a blood pressure sensor, a single-axis accelerometer, a multi-axis accelerometer, a global positioning system (GPS), a gyroscope, any other suitable sensor for capturing motion information associated with the user or physiological or biometric data, and any combination thereof.

The transmitter 315 transmits raw data to a portable computing device 106 or the activity classification server 100 at various frequencies based on characteristics of the raw data. Characteristics of raw data or feature points in the raw data describe changes in patterns in the raw data such as a data point in the raw data that differs from one or more previous data points in the raw data. For example, if the raw data describes acceleration in a vertical direction, a characteristic of the raw data can describe magnitude of the acceleration and, therefore, a change in pattern can be a change in magnitude. Other examples of characteristics include changes in VO2 levels, lactate levels, blood glucose levels, duration, and any other suitable characteristic of data that can be measured by the one or more sensors in the sensor unit 210. In various examples, the characteristics of raw data can be used to detect patterns to identify whether a user is performing an activity, to identify whether a user is performing an activity properly or safely, to identify whether a user is suffering a condition while performing an activity, to identify whether the user may have early onset of a disease, or to enhance patient care monitoring.

Characteristics can be detected and analyzed in the processor using instructions stored in memory in one embodiment. Embodiments of a processor include a microprocessor, a central processing unit (CPU), a graphics processing unit (GPU), a digital signal processor (DSP), one or more application specific integrated circuits (ASICs), one or more field programmable gate arrays (FPGAs), one or more programmable logic devices (PLDs), or any combination thereof. Embodiments of memory include flash memory, random-access memory (RAM), read-only memory (ROM), or any combination thereof. Alternatively, instructions can be stored in the processor's cache instead of in memory.

The transmitter 315 also transmits the raw data to the activity classification server 100 that communicates with a portable computing device 106 or an application executing on the portable computing device 106. The activity classification server 100 can store the received raw data and send indications to one or more of the activity-tracking devices 102 to dynamically adjust a sampling rate for data acquisition as further described below in conjunction with FIG. 4. For example, the indications can be sent to the portable computing device 106 to be communicated to the activity-tracking devices 102.

In one embodiment, the power source 320 includes a lithium polymer battery or any other suitable battery. Alternatively, the power source 320 can include a charging apparatus built into the wearable device 102 in addition to the battery. The coupling mechanism 325 can be a ring-like structure (e.g., a wristband, armband, legband, headband, neck strap, etc.), a clip, Velcro, or any other suitable customizable and/or attachable mechanism.

In some embodiments, the activity-tracking devices 102 include a user interface that allows the user to interact with the device. For example, one or more of the devices 102 can include a screen that allows the user to see reported information from the devices 102. The devices 102 can also include buttons, switches, mouse pads, etc. that allow the user to interact and provide input to the devices 102. In some cases, only one of the devices 102 (e.g., on the wrist) includes a user interface, and the other(s) do not (e.g., the shoe clip).

### Synchronization of Activity-Tracking Devices

FIG. 4 is a method of synchronizing a plurality of activity-tracking devices 102 for use by a user. In various embodiments, the steps described in conjunction with FIG. 4 may be performed in different orders. Additionally, in some embodiments, the method may include different and/or additional steps from those shown in FIG. 4. The functionality described in conjunction with an application associated with the activity classification server 100 executing on a client device in FIG. 4 may also be provided by the sampling adjustment module 220, in one embodiment, or may be provided by any other suitable component, or components, in other embodiments.

A portable computing device 106 (or client device associated with a user) or the activity classification server 100 receives 405 an indication from a user of the client device to set up a plurality of activity-tracking devices. For example, the client device receives 405 the indication via an application executing on the client device that is associated with the activity classification server 100. In one embodiment, the indication can be interaction by the user with the application. For example, the interaction with the application can include a user selection to begin acquisition of raw data since the user will begin an activity. Alternatively, the indication can be based on temporal information and/or geographic information of the user. For example, if the user regularly exercises from 6 am to 7 am, then the indication can simply be that the time is 6 am. If the user regularly exercises at a gym near home, then the indication can be that the user is located at the gym. This indication can be received at the client device and in some cases passed on by the client device 106 to the server 100. In some embodiments, the indication may be sent directly to the server 100 or to both the server 100 and the client device 106.

Responsive to receiving the indication, instructions are communicated 410 to one or more of the plurality of activity-tracking devices 102, where the instructions include one or more preliminary sampling rates associated with one or more sensors included in the plurality of activity-tracking devices 102. These instructions can come from either the client device 106 or the server 100. In one embodiment, the preliminary sampling rate can be the same for a type of sensor. For example, the preliminary sampling rate for a motion sensor will be the same for a motion sensor in the activity-tracking device 102 attached to the upper body and for a motion sensor in the activity-tracking device 102 attached to the lower body. The instructions can include a preliminary sampling rate for one or more biosensors included in the plurality of activity-tracking devices 102 as well, and the preliminary sampling rate for a biosensor will be the same for a biosensor in the activity-tracking device 102 attached to the upper body and for a biosensor in the activity-tracking device 102 attached to the lower body.

The portable computing device 106 and/or the server 100 receives 415 a second indication that one or more sensors of the plurality of activity-tracking devices 102 are sampling at the preliminary sampling rates. Alternatively, the portable computing device 106 and/or server 100 receives 415 indications from each of the sensors included in the plurality of activity-tracking devices 102, each received 415 indication from a sensor indicating that the sensor is sampling at the corresponding preliminary sampling rate. This ensures that, if there is a plurality of sensors, the activity-tracking devices 102 including the plurality of sensors are synchronized prior to use and analysis of raw data and the synchronization of the plurality of sensors can be performed via a portable computing device 106 or via an application executing on the portable computing device 106. Therefore, if the sampling rate of a sensor was adjusted previously for another exercise, the sampling rate can be adjusted so meaningful data can be acquired by the activity-tracking devices 102 for future activities. For example, if the previous activity tracked by the activity-tracking devices 102 was bicep curls, then the sampling rate of a motion sensor in an activity-tracking device 102 attached to the lower body may have been reduced since no meaningful data comes from the lower body during bicep curls. If the next activity to be performed, however, is squats, then tracking the lower body does provide meaningful data regarding the load the lower body is bearing during squats.

The portable computing device 106 presents 420 a notification to the user that the plurality of activity-tracking devices is ready to use. In one embodiment, the notification can be presented 420 responsive to receiving 415 the second indication. The notification can be presented 420 via the application executing on the portable computing device 106 associated with the activity classification server 100. In another embodiment, the notification is presented on or by one or more of the activity-tracking devices (e.g., on a screen, via haptic feedback, via an audible notification, via a flashing light or other visual notification, etc.). In some embodiments, the notification can come from the server 100 for presentation on the device 106 or on the activity-tracking devices.

### Dynamic Adjustment of Sampling Rates of Activity-Tracking Devices

FIG. 5 is a method of the activity classification server 100 dynamically adjusting sampling rates of one or more activity-tracking devices, in accordance with an embodiment. In various embodiments, the steps described in conjunction with FIG. 5 may be performed in different orders. Additionally, in some embodiments, the method may include different and/or additional steps from those shown in FIG. 5. The functionality described in conjunction with the activity classification server 100 in FIG. 5 may be provided by the sampling adjustment module 220, in one embodiment, or may be provided by any other suitable component, or components, in other embodiments. In some embodiments, some or all of the steps below occur at the portable device 106 or at one or both of the activity-tracking devices.

The activity classification server 100 receives 505 raw data from one or more activity-tracking devices 102. The raw data includes one or more points where each point associated with a time stamp and amplitude and represents an activity level (e.g., motion) of a user using the one or more activity-tracking devices 102 through the points in the data (e.g., points in a graphical representation of the data). The point can be a measurement taken by a sensor in an activity-tracking device 102. For example, if the sensor is a motion sensor such as an accelerometer, the point can be a measurement of change in a unit in a specified axis at a point in time such as a change in ten units in the x-axis direction after ten seconds of using the activity-tracking device 102 including the motion sensor. If the sensor is a temperature sensor such as a thermocouple, the point can be a measurement of the temperature at a specified point in time such as 95° F. after fifteen seconds using the activity-tracking device 102 including the temperature sensor. As stated previously, each point in the raw data is associated with a time stamp and amplitude (e.g., measure of change in unit such as inches in a direction, temperature measurement). Thus, for motion data, the amplitude represents how much the activity-tracking device 102 is moving and represents motion of a user using the activity-tracking device 102. In one embodiment, for a plurality of activity-tracking devices 102, the raw data includes a plurality of data streams associated with each of the plurality of activity-tracking devices 102. In an alternative embodiment, the raw data is a combined data stream of each of the one or more activity-tracking devices 102 and each point can be associated with the corresponding data stream in the combined data streams acquired by one or more of the activity-tracking devices 102.

A request to monitor the raw data acquired by the plurality of activity-tracking devices is received 510. The request can come from the device 106 or the activity-tracking devices, and the request can be received by the server 100 and/or by the device 106. The request can be based on a setting indicating that the raw data should be monitored periodically, or the request can simply be the start of activity by the user that indicates that there is an activity occurring to be tracked. Alternatively, the request can be a request from the user via a portable computing device 106 operated by the user. For example, if the user is beginning an activity, the user can begin an application associated with the activity classification server 100 and the interaction with the application can be the request or the indication received from the user, as previously described in conjunction with FIG. 4, can be the request. In some embodiments, there is no request received 510, but instead the raw data is received 505 and the monitoring of the raw data automatically occurs by the server 100.

The activity classification server 100 determines 515 a state of the user where the state describes one or more physical conditions of the user while using the plurality of activity-tracking devices 102. In one embodiment, the state of the user can be determined 515 based on temporal information, geographical information, motion information of the user, and any other suitable information describing the user. For example, time stamps associated with points in the raw data can be used to determine 515 the state of the user. If the user is expected to be sleeping at a certain time interval, then time stamps included in that time interval can be associated with the activity of sleeping and the state of the user can be determined 515 as “sleeping” or “no activity.”

As an example of geographical information, the user's location can be determined from GPS information and certain activities can be eliminated as possibilities for the user. If the user is at a location associated with “home,” then other activities such as “hiking” can be eliminated and the state of the user can be determined 515 as “at home.” Similarly, if the user is at a location associated with a restaurant, then certain upper body movement (e.g., hand motion towards and away from the mouth) can be correlated with the location to determine the state of the user as “eating” or “at a restaurant.”

Other suitable geographical information can include orientation of one or more sensors in the one or more activity-tracking devices 102. If the orientation of a sensor is upside down, for example, compared to the orientation of the sensor during use by the user while performing an activity, the activity classification server 100 can determine 515 that the sensor is not being used and, possibly, not worn by the user at that time. Thus, the state of the user can be determined 515 to be “idle” or “not using the activity-tracking devices 102.” Similarly, if the orientation of the sensor is upside down for less than a threshold amount of time and for at least a threshold number of repetitions, then the activity classification server 100 can determine 515 that the user is performing an activity that requires at least a portion of his or her body to be upside down, determining 515 the state of the user to be “performing an activity.”

Further, geographic information can include information describing proximity of the user or one or more of the activity-tracking devices 102 with other devices or equipment. For example, if the user is in the gym, the geographic information can include signal strength of fitness equipment that can be connected to one or more of the activity-tracking devices 102 and/or the portable computing device 102 of the user and, if the signal strength exceeds a threshold signal strength, the state of the user can be determined 515 as “exercising” or “at the gym.”

Motion information of the user can include notable variations in the raw data. For example, if there is at least a threshold net change in distance or acceleration in a direction, the state of the user can describe a significant change in the direction. For example, if a user is sitting and suddenly stands up, the activity classification server 100 can identify a sudden change in amplitude of the raw data (e.g., a spike in an amplitude indicative of a change in the z-axis or a change in the vertical direction, a change in net acceleration in the vertical direction or z-axis) in an activity-tracking device worn on the upper body. Thus, the state of the user can be determined 515 as “change in activities,” “beginning an activity,” “ending an activity,” or “performing an activity.” This type of change in state data can also be used to determine when to start tracking activities (e.g., start tracking when there is a large change in net acceleration) or when to increase sampling rate because an activity is beginning.

Similarly, absence of variation in raw data can be identified to determine 515 the state of the user as “idle” or “performing an activity associated with minimal movement.” Then, change in absence of variation can be identified to determine 515 the state of the user as “beginning an activity” or “ending an activity.” For example, if the user is running and slows down to walking, there was absence of variation in the data while the user was running and also absence of variation in the data when the user was walking. The change in absence of variation is the change from running to walking.

The state of the user can also be determined 515 based on previously acquired raw data. For example, if a state of the user is determined 515 as “idle” or “performing an activity associated with minimal movement” from 9 pm to 6 am for a threshold number of days, then the activity classification server 100 can determine 515 the state of the user for the following day from 9 pm to 6 am to be “sleeping” with a degree of certainty.

Based on the determined 515 state of the user, the activity classification server 100 automatically computes 520 one or more adjusted sampling rates at which one or more sensors included in the plurality of activity-tracking devices should sample the raw data. The server 100 can make this determination without input from the user. If the determined state of the user is “performing an activity,” the one or more adjusted sampling rates can be determined 520 for the activity based on a sampling rate database that includes a threshold sampling rate required for one or more of the activity-tracking devices 102 for a certain activity. For example, if the state of the user is determined 515 to be “performing an activity” or “squats,” then the adjusted sampling rate of an activity-tracking device 102 associated with a lower body of the user can be determined 520 to exceed a threshold sampling rate to acquire meaningful data describing the load the lower body or limb of the lower body is bearing as a result of the toes and feet trying to balance and assist in moving and manipulating that load. If the state of the user is determined 515 as “sitting,” then the adjusted sampling rate of an activity-tracking device 102 associated with a lower body of the user can be determined 520 to be less than a threshold sampling rate since there is no meaningful data associated with the lower body.

If the determined state of the user is “beginning an activity” or “ending an activity,” then the activity classification server 100 can determine an activity based on the state and then determine 520 adjusted sampling rates based on the activity. If the determined 515 state is “beginning the activity of sleeping,” then the determined 520 adjusted sampling rate would be less than a threshold sampling rate since there may be no meaningful data while sleeping for the user or a threshold amount of raw data has already been acquired of the user sleeping. If the determined 515 state is “ending exercising at the gym,” then the determined 520 adjusted sampling rate would be greater than a threshold sampling rate since heart rate is important for calorie burn after exercising at the gym and there may be less than a threshold amount of raw data acquired for the state of “ending exercising at the gym,” for example compared to “sleeping.” Similarly, if the determined 515 state is “ending an activity” due to a change in variation in the raw data, the activity classification server 100 may automatically sample one or more of the sensors on one or more of the activity-tracking devices 102 at a high sampling rate or a sampling rate exceeding a high threshold rate since the user may be beginning another activity. Then, after an interval of time, the activity classification server 100 may sample at a lower sampling rate or a sampling rate less than a lower threshold rate if no variation is found in the raw data. If a user begins the activity or “running,” then, after ten minutes, the user may still be running and no variation may be identified in the raw data. Thus, the sensors on the activity-tracking devices 102 can be sampling at a lower sampling rate since sampling at a higher sampling rate does not necessarily acquire more meaningful data after ten minutes.

The one or more adjusted sampling rates are communicated 525 to the one or more of the plurality of activity-tracking devices 102 where each of the one or more adjusted sampling rates are associated with a sensor identification of a sensor in the activity-tracking device 102. In one embodiment, the activity classification server 100 transmits an instruction to the one or more of the plurality of activity-tracking devices 102 to adjust the sampling rate associated with the corresponding sensor according to the adjusted sampling rates. Alternatively, the adjusted sampling rates are communicated 525 to a portable computing device 106 or client device associated with the user and the portable computing device 106 communicates the one or more adjusted sampling rates to the one or more of the plurality of activity-tracking devices 102. The one or more of the plurality of activity-tracking devices 102 then adjusts the sampling rate of the associated sensors identified by the sensor identifications.

With this method, the system shown in FIG. 1 can automatically control the sampling rate and adjust according to the user's day and the user's activities without requiring the user to provide input or other data, such as the time, the user location, an indication of the activity being performed, a request to start or stop the tracking, etc. The system can simply collect the information needed to automatically determine what adjustments to make to the sampling rate and can thus apply the sampling rate that is appropriate for the activity being performed. In addition, the system can avoid the need to constantly track at a high sampling rate in case an activity is being performed, which can be inefficient for the device, or alternatively avoid tracking constantly at a low sampling rate to be efficient and end up missing valuable data points in the activity. Instead, the tracking is automatically tailored to the situation and possibly even specifically to the user and his schedule or typical daily activities.

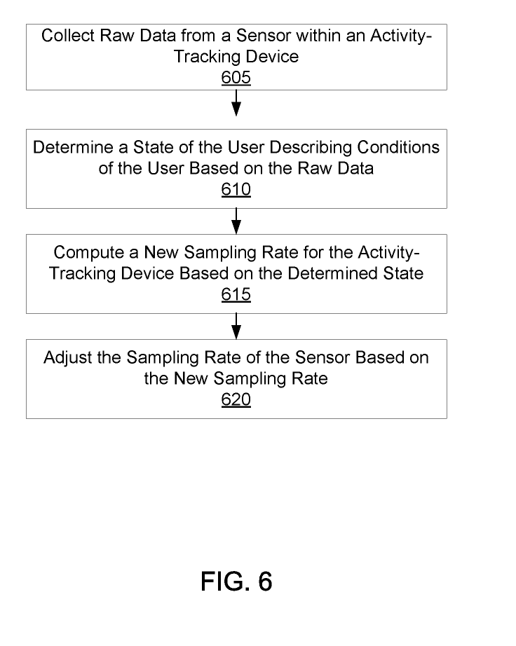

FIG. 6 is a method of dynamically adjusting a sampling rate of an activity-tracking device, in accordance with an embodiment. In various embodiments, the steps described in conjunction with FIG. 6 may be performed in different orders. Additionally, in some embodiments, the method may include different and/or additional steps from those shown in FIG. 5. The steps below can occur on one or on more than one of the activity-tracking devices. In some embodiments, some or all of the steps below occur at the portable device 106 or at the server 100.

An activity-tracking device 102 collects raw data from at least one sensor included in the device. The sensor captures the raw data at a given sampling rate. The raw data may include activity information and/or, physiological information associated with a user wearing the device. The activity-tracking device determines 610 a state of the user where the state describes one or more physical conditions of the user while wearing the device. In one embodiment, the state of the user can be determined 610 based on temporal information, geographical information, motion information of the user, and any other suitable information describing the user.

Based on the determined state of the user, the activity-tracking device 102 automatically computes 615 a new sampling rate at which the at least one sensor included in the activity-tracking device should sample the raw data. The sampling rate may be adjusted based on factors such as where the user is located, the type of movement in which the user is engaged, the length of time the user has been engaged in a particular movement and/or activity, the orientation of the sensor, and the proximity of the sensor to other devices or equipment. The activity-tracking device 102 adjusts 620 the sampling rate of the sensor based on the new sampling rate.

As another embodiment, the activity-tracking device 102 may not perform the computation or determination, but instead these are performed at the server 100 (or at device 106), as described above for FIG. 5. In this case, the device(s) 102 receive instructions from the server 100 and perform the adjustment 620 of the sampling rate based on the instructions. The method can continue with one or more of the devices 102 sending raw data to the server 100 over time, and receiving instructions back from the server 100 for different adjustments to the sampling rate (e.g., increases or decreases in sampling rate), and then the devices 102 can adjust to the new sampling rate according to the instructions.

### Computing Machine Architecture

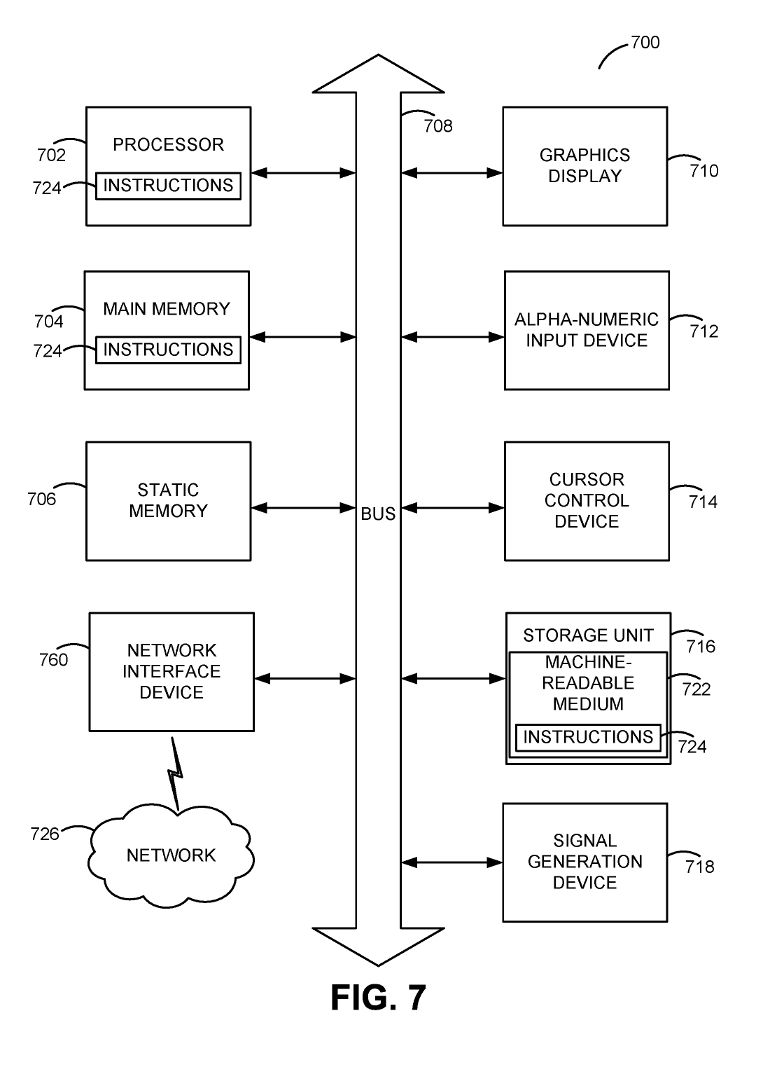

FIG. 7 is a block diagram illustrating components of an example machine able to read instructions (e.g., software or program code) from a machine-readable medium and execute them in a processor (or controller), in accordance with an embodiment. The example machine shows one or more components that may be structured, and operational, within a computing device 106 70 and/or a classification server 100. Specifically, FIG. 6 shows a diagrammatic representation of a machine in the example form of a computer system 700 within which instructions 724 (e.g., software or program code) for causing the machine to perform any one or more of the methodologies discussed herein may be executed. The methodologies can include the modules described with FIG. 1 and subsequently herein. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors (generally processor 702) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a dynamic memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 760, which also are configured to communicate via the bus 708. In addition, the computer system 700 may include one or more positional sensors, e.g., an accelerometer or a global position system (GPS) sensor, connected with the bus 708. In addition, the network interface device 760 may include a WiFi or “cellular” mobile connection that also can be used to help identify locational information.

The storage unit 716 includes a machine-readable medium 722 on which are stored instructions 724 embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 760. It is noted that the database 130 can be stored in the storage 716 although it also can be stored in part or whole in the memory 704.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This system includes apparatuses that may be specially constructed for the required purposes (e.g., specially designed activity-tracking devices for tracking certain activities), and it may include one or more general-purpose computing devices selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, by an activity classification server, raw data from a plurality of activity-tracking devices worn by a user while performing an activity, each of the activity-tracking devices capturing the raw data at a corresponding sampling rate;
determining a state of the user based at least on the raw data, the state describing one or more physical conditions of the user while using the plurality of activity-tracking devices;
for at least one of the plurality of activity-tracking device, transmitting an instruction to the activity-tracking device for adjusting the corresponding sampling rate based on the determined state of the user; and
receiving, by the activity classification server, additional raw data from the at least one of plurality of activity-tracking devices, the at least one of plurality of activity-tracking devices activity-tracking device capturing the additional raw data at the adjusted sampling rate.

2. The method of claim 1, wherein determining the state of the user is based on a user profile associated with the user.

3. The method of claim 2, wherein the raw data indicates a time of day, and determining the state of the user comprises determining from the user profile an activity pattern that the user engages in during the time of day.

4. The method of claim 2, wherein the raw data indicates a geographical location of the user, and determining the state of the user comprises determining from the user profile an activity pattern that the user engages in when in or within a threshold distance from the geographical location.

5. The method of claim 1, wherein the raw data indicates a geographical location and a type of motion of the user, and determining the state of the user comprises correlating the geographical location and the type of motion to the determine the state of the user.

6. The method of claim 1, wherein the raw data comprises a plurality of points, each point associated with a time stamp and amplitude representing a quantity by which a first activity-tracking device from which the raw data was received moved.

7. The method of claim 6, wherein determining the state of the user is based on a change in amplitude between at least two of the plurality of points.

8. The method of claim 6, further comprising determining that the sampling rates corresponding to the plurality of activity-tracking devices should be adjusted based on a change in amplitude between at least two of the plurality of points.

9. The method of claim 1, wherein, for a given activity-tracking device, adjusting the corresponding sampling rate comprises matching the determined state with an activity pattern, and setting the corresponding sampling rate to a second sampling rate associated with the activity pattern.

10. The method of claim 1, wherein, for a given activity-tracking device, adjusting the corresponding sampling rate comprises determining, based on the determined state, an amount by which a portion of the user's body on which the activity-tracking device is moving, and adjusting the sampling rate based on the amount of movement.

11. A computer readable medium storing instructions that, when executed by a processor, cause the processor to perform the steps of:
receiving, by an activity classification server, raw data from a plurality of activity-tracking devices worn by a user while performing an activity, each of the activity-tracking devices capturing the raw data at a corresponding sampling rate;
determining a state of the user based at least on the raw data, the state describing one or more physical conditions of the user while using the plurality of activity-tracking devices;
for at least one of the plurality of activity-tracking device, transmitting an instruction to the activity-tracking device for adjusting the corresponding sampling rate based on the determined state of the user; and
receiving, by the activity classification server, additional raw data from the at least one of plurality of activity-tracking devices, the at least one of plurality of activity-tracking devices capturing the additional raw data at the adjusted sampling rate.

12. The computer readable medium of claim 11, wherein determining the state of the user is based on a user profile associated with the user.

13. The computer readable medium of claim 12, wherein the raw data indicates a time of day, and determining the state of the user comprises determining from the user profile an activity pattern that the user engages in during the time of day.

14. The computer readable medium of claim 12, wherein the raw data indicates a geographical location of the user, and determining the state of the user comprises determining from the user profile an activity pattern that the user engages in when in or within a threshold distance from the geographical location.

15. The computer readable medium of claim 11, wherein the raw data indicates a geographical location and a type of motion of the user, and determining the state of the user comprises correlating the geographical location and the type of motion to the determine the state of the user.

16. The computer readable medium of claim 11, wherein the raw data comprises a plurality of points, each point associated with a time stamp and amplitude representing a quantity by which a first activity-tracking device from which the raw data was received moved.

17. The computer readable medium of claim 16, further comprising determining that the sampling rates corresponding to the plurality of activity-tracking devices should be adjusted based on a change in amplitude between at least two of the plurality of points.

18. The computer readable medium of claim 11, wherein, for a given activity-tracking device, adjusting the corresponding sampling rate comprises matching the determined state with an activity pattern, and setting the corresponding sampling rate to a second sampling rate associated with the activity pattern.

19. The computer readable medium of claim 11, wherein, for a given activity-tracking device, adjusting the corresponding sampling rate comprises determining, based on the determined state, an amount by which a portion of the user's body on which the activity-tracking device is moving, and adjusting the sampling rate based on the amount of movement.

20. An activity classification server communicatively coupled to a plurality of activity-tracking devices, comprising:
a memory storing instructions; and
a processor for executing the instructions to perform the steps for:
receiving raw data from the plurality of activity-tracking devices worn by a user while performing an activity, each of the activity-tracking devices capturing the raw data at a corresponding sampling rate,
determining a state of the user based at least on the raw data, the state describing one or more physical conditions of the user while using the plurality of activity-tracking devices,
for at least one of the plurality of activity-tracking device, transmitting an instruction to the activity-tracking device for adjusting the corresponding sampling rate based on the determined state of the user, and
receiving, by the activity classification server, additional raw data from the at least one of plurality of activity-tracking devices, the at least one of plurality of activity-tracking devices capturing the additional raw data at the adjusted sampling rate.
